(19) United States
(12) Patent Application Publication
(10) Pub. No.: US 2015/0199282 A1
(43) Pub. Date: Jul. 16, 2015

(54) SCRAMBLE RANDOM SEED PREDICTION METHOD WITH STORAGE DEVICE BUILT-IN DATA COPY BACK PROCEDURE

(71) Applicant: Storart Technology Co., Ltd., Hsinchu (TW)

(72) Inventors: CHIH-NAN YEN, HSINCHU (TW); CHIEN-CHENG LIN, HSINCHU (TW); SZU-I YEH, HSINCHU (TW)

(73) Assignee: Storart Technology Co., Ltd., Hsinchu (TW)

(21) Appl. No.: 14/157,487

(22) Filed: Jan. 16, 2014

(51) Int. Cl. G06F 12/14; G06F 21/60

(52) U.S. Cl. CPC G06F 12/1408; G06F 21/602

(57) ABSTRACT

A scramble random seed prediction method with the storage device built-in data copy back procedure is disclosed. The method may predict a scramble random seed before first time programming. The data may be programmed with the scramble random seed based on the pager number of the block B, not block A, before programming data to block A. After data is moved from block A to block B with the storage device built-in data copy back procedure, the data in block B may be have the best scramble random seed. Therefore, compared to the conventional method of scrambling data or data movement, the moved data of this invention may be much more stable with the storage device data copy back procedure.

### FIELD OF THE INVENTION

The present invention provides a scramble random seed prediction method with the storage device built-in data copy back procedure.

### BACKGROUND OF THE INVENTION

The new generation storage device (such as flash memory) is sensitive to data pattern. If data pattern programmed to a storage device is dull, the data would be disturbed easily. In order to avoid this situation, the controller would scramble data before programming data to the storage device. The storage device makers also suggest a best scramble rule to protect data from being unstable. The best scramble rules usually depend on programmed page number.

Please refer to FIG. 1, which shows a schematic view of a conventional method of scrambling data in a storage device. The controller sometimes needs to move data from the page N of the block A to the page M of the block B based on a predetermined design algorithm. The data in the page N of the block A is read and de-scrambled to a SRAM in controller first, and then re-scrambled data with a new random seed that the storage device makers suggested and program data to the page M of the block B.

In order to enhance data movement efficiency, controller will use the storage device built-in data copy back procedure to move data from the page N of the block A to the page M of the block B without reading the data to the buffer of the controller. The data pass through storage device internal register and program to another address directly. It means moved data move from the page N of the block A to the page M of the block B without re-scrambled. Moved data without re-scramble is more unstable than the data with re-scrambled, because the random seed maybe not match the value that storage device maker suggested.

Please refer to FIG. 2, which shows a schematic view of a conventional method for enhancing data movement efficiency with the storage device built-in data copy back procedure. In order to enhance the data movement efficiency, controller may be used the storage device built-in data copy back procedure to move data from the page N of the block A to the page M of the block B. But the storage device built-in data copy back procedure won't read out data to the buffer of the controller, only let data pass through the storage device internal register and program to another address without re-scrambled. The moved data without re-scrambled is more unstable than data with re-scrambled.

### SUMMARY OF THE INVENTION

An objective of this invention is providing a method to predict a scramble random seed before first time programming. The data may be programmed to the page N of block A, and the data management algorithm predict that the data would be moved to the page M of the block B later. The scramble random seed with the data programmed to the page N of block A, would be related to the page M. After data is moved from the page N of the block A to the page M of the block B with the storage device built-in data copy back procedure, the data in the page M of the block B may be have the best scramble random seed which is related to the page M.

To achieve above objectives, a scramble random seed prediction method with the storage device built-in data copy back procedure is provided, and the steps of the method are comprising:
step S1: a data is ready to be programmed to a storage device;
step S2: predicting a page M inside a block B and starting to program the data;
step S3: programming the data to a page N inside an another block A with a scramble random seed relative to the page M; and
step S4: moving the data from the page N of the block A to the page M of the block B with the storage device built-in copy back procedure.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a schematic view of a conventional method of scrambling data in a storage device.

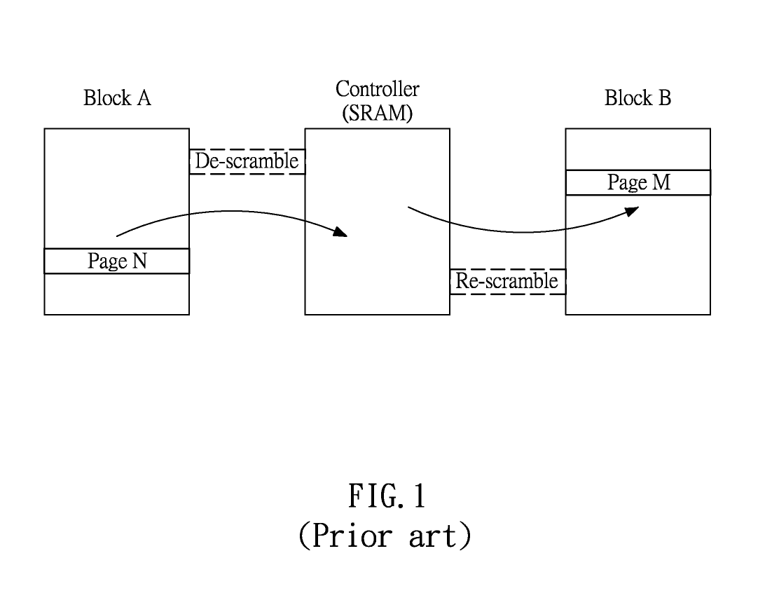

FIG. 2 is a schematic view of a conventional method for enhancing data movement efficiency with the storage device built-in data copy back procedure in a storage device.

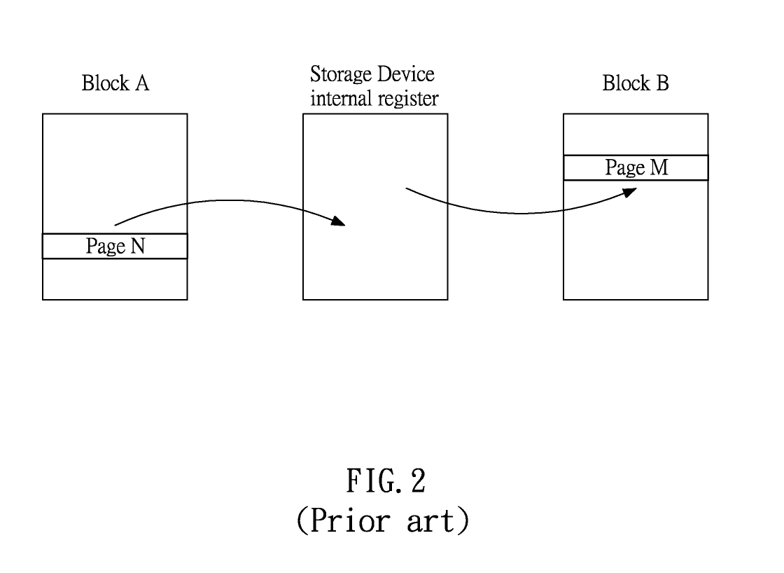

FIG. 3 is a flowchart of a scramble random seed prediction method with the storage device built-in data copy back procedure according to an embodiment of present invention.

FIG. 4 is a schematic view of a scramble random seed prediction method with the storage device built-in data copy back procedure according to an embodiment of present invention.

### DESCRIPTION OF THE PREFERRED EMBODIMENT

Referring now to the drawings where like characteristics and features among the various figures are denoted by like reference characters.

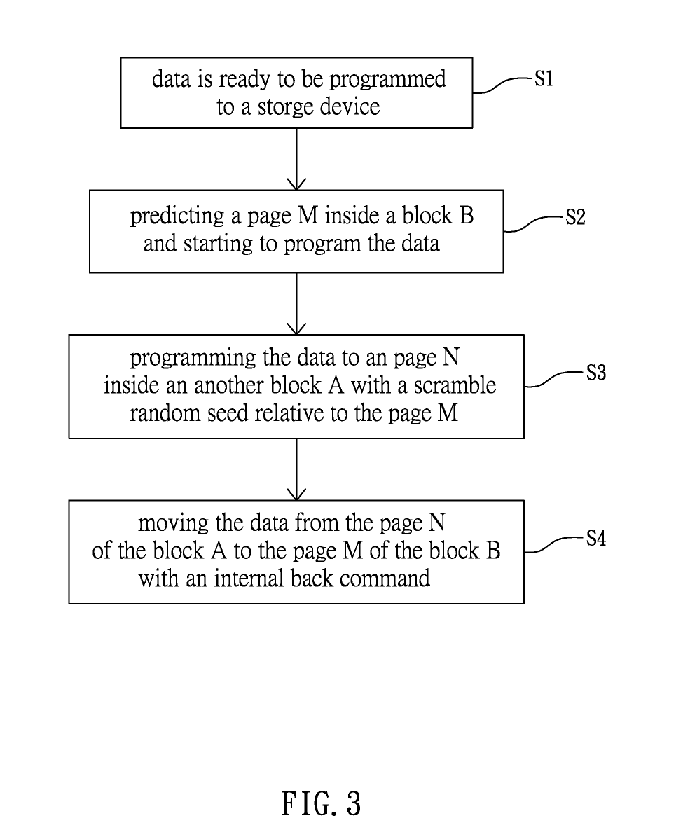

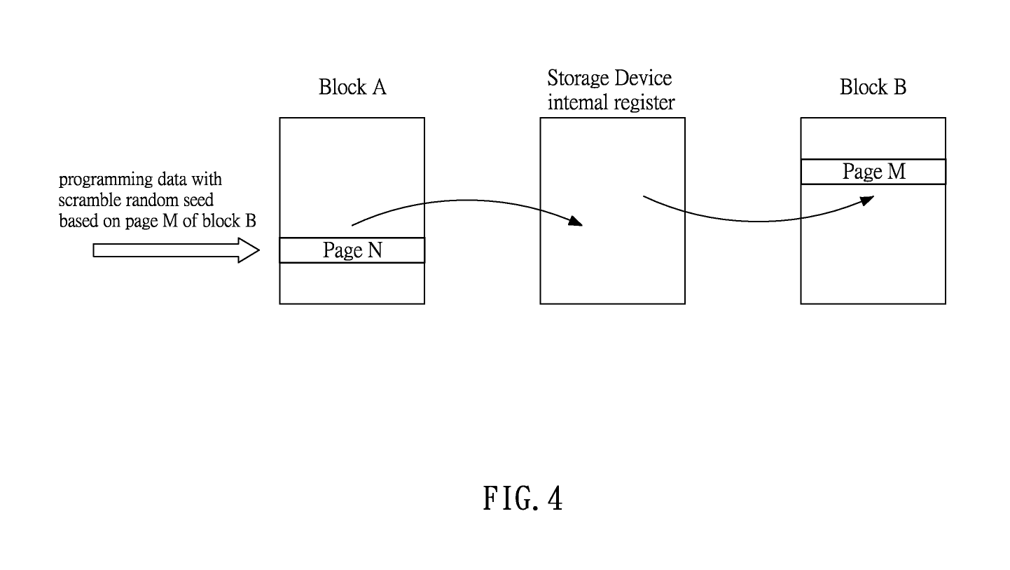

Please refer to FIG. 3, which shows a flowchart of a scramble random seed prediction method with the storage device built-in data copy back procedure according to an embodiment of present invention. And please also refer to FIG. 4, which shows a schematic view of a scramble random seed prediction method with the storage device built-in data copy back procedure according to an embodiment of present invention.

The scramble random seed prediction method with the storage device built-in data copy back procedure is provided and the steps are:
step S1: a data is ready to be programmed to a storage device (such as a flash memory);
step S2: predicting a page M inside a block B and starting to program the data;
step S3: programming the data to an page N inside an another block A with a scramble random seed relative to the page M; and
step S4: moving the data from the page N of the block A to the page M of the block B with the storage device built-in data copy back procedure.

That is, conventionally, the controller may program data to page N of the block A with scramble random seed is relative to page N. In the invention, it is predicted that the data programmed to page N of the block A would be moved to the page M of block B, the scramble random seed with the data programmed to the page N of block A would be related to the page M. As an example, if controller received the host data, which would be programmed to Page 3 of the Block 5. And the data management algorithm predicts that the data would be moved to the Page 100 of the Block 10 later. The scramble random seed programmed with the data shall be a scramble random seed related to Page 100.

Therefore, compared to the conventional method of scrambling data or data movement, the moved data of this invention may be much more stable with the storage device built-in data copy back procedure.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. A scramble random seed prediction method for a storage device built-in with a data copy back procedure, comprising the steps of:
selecting a page M of a block B as a destination for a data which is ready to be programmed to a page N of block A which is a different block from the block B;
programming the data to the page N of the block A with a scramble random seed relative to the page M of the block B; and
moving the data from the page N of the block A to the page M of the block B with the data copy back procedure.

2. The method according to claim 1, wherein the storage device is a flash memory.
